(19) United States
(12) Patent Application Publication
(10) Pub. No.: US 2023/0390155 A1
(43) Pub. Date: Dec. 7, 2023

(54) Portable Preservation System

(71) Applicant: Desert Valley Tech Inc., Mesa, AZ (US)

(72) Inventors: Clint Solomon, Gilbert, AZ (US); Burt Skiba, Mesa, AZ (US); Jeffry Skiba, Chandler, AZ (US); Travis Witzke, Scottsdale, AZ (US)

(21) Appl. No.: 18/204,765

(22) Filed: Jun. 1, 2023

Related U.S. Application Data
(60) Provisional application No. 63/347,626, filed on Jun. 1, 2022.

(51) Int. Cl. A61J 1/05; A61J 1/14

(52) U.S. Cl. CPC A61J 1/05; A61J 1/1468; A61J 2200/44

(57) ABSTRACT

A portable preservation system comprising an outer container having at least one open end. An insulative layer wherein the insulative layer is placed in and coupled to the outer container. At least one supply line and at least one return line wherein at least one coil can be coupled between the supply line and the return line wherein the coil partially surrounds an inner container and a cap. The inner container can have at least one compartment. The insulative layer can be coupled between the coils and the outer container.

### CROSS-REFERENCE TO RELATED APPLICATIONS

This application claims benefit from currently pending U.S. Provisional Application No. 63/347,626 titled “Portable Preservation System” and having a filing date of Jun. 1, 2022, all of which is incorporated by reference herein.

### TECHNICAL FIELD

The present invention relates to a portable environmental storage, preservation, and a transportation system more particularly, a portable storage system.

### BACKGROUND

Various types of devices are used for safely storing and carrying vaccines, blood, plasma, biofilms, and organs collectively referred to as biomaterials or biologics. For example, military field medics carry medical equipment that can weigh from 50 lbs. to 80 lbs. including bandages, saline, tourniquets, tubing, gauze, and other lifesaving materials. However, current devices require the field medic to carry an insulated container that is passively cooled with ice, requiring a bulky freezer or refrigerator to keep lifesaving biomaterials at the recommended storage conditions. Because each of these biomaterials have a recommended storage condition to be viable, multiple devices are needed to accommodate each storage condition. For example, human organs and vaccines must be transported at different conditions to keep the vaccines potent, and human organs from dying than blood products, and pharmaceuticals. Current mobile storage devices for lifesaving biomaterials are passively cooled meaning the device use ice, or ice products such as ice packs with thick Styrofoam lined shells. The passive storage of biomaterials has a number of disadvantages including, ice melting causing condensation on the organ or blood spoiling the product. Ice will additionally create inconsistent temperature variation within the container causing an uncertainty of whether the biomaterials are viable or as potent. This device will expand the capability of shipping containers by enabling tracking of the contents, real time delivery of informatics on the contents condition and actual location to anticipate delivery time of arrival.

Blood products such as plasma, platelets, red blood cells, or whole blood usually come in blood bags and must be stored at specific temperatures to maintain freshness and usability. Using ice, or ice-like packs can cause inconsistencies within the temperature range of the blood inside the bag creating uncertainties regarding whether the blood is safe for transfusion. The blood product, usually delivered in a blood bag, must be in contact with heavy ice or ice packs to stay within a certain temperature range. The areas of ice not in contact with the blood bag results in higher temperatures which may exceed acceptable storage temperatures where the blood or plasma product could spoil. In addition, the storage environment of different types of blood products varies in temperature, for example, whole blood must be stored between 1 to 6 degrees Celsius and cannot freeze, plasma must be stored at −18 degrees Celsius or colder, and platelets must be stored between 20 to 24 degrees Celsius. Using ice or ice packets can only give off a baseline temperature of around 0 degrees Celsius. There is not currently a portable product on the market today that can adjust to a set temperature and to different required environmental conditions to fit the different types of blood products, organs, and vaccines in remote locations.

A further disadvantage of the use of ice or ice packets for storing biomaterials is that ice is heavy, turns from solid to liquid as it melts and requires a freezer to refreeze it. In a disaster area or where military casualties require blood, the blood is usually taken from the donor from a hospital or from the military base. Once the blood is taken it is placed into a blood storage refrigerator until it is shipped. At that time, it is transferred into a shipping container along with ice and the countdown starts for when that blood will eventually be unusable. If the blood product is not transfused into an injured person, the precious blood will be thrown out if not used. Therefore, there must be an ample supply of ice as the blood products, organs, and vaccines are transported from location to location, which just is not available at the front line of a military conflict.

Therefore, it would be advantageous to provide a storage and preservation storage system that can be actively cooled by a docking station and then when undocked stay cool for days when by its own passive cooling.

### SUMMARY

Aspects disclosed herein relates to a portable preservation system comprising an outer container having at least one open end. An insulative layer wherein the insulative layer is placed in and coupled to the outer container. At least one supply line and at least one return line wherein at least one coil can be coupled between the supply line and the return line wherein the coil partially surrounds an inner container and a cap.

The inner container can have at least one compartment. The insulative layer can be coupled between the coils and the outer container. The insulative layer is phase change material. The coil can be copper tubing. The coils can be coupled to a manifold wherein the manifold evenly disburses a coolant throughout the coils. The cap comprises an outer cap and inner cap wherein the inner cap is a cap insulative layer. The supply line and the return line can be quick disconnects. The coils further can comprise fins wherein the fins are coupled to or come into contact with the insulative layer and the inner container. The outer container can be dual walled vacuum insulated stainless steel.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 shows an isometric view of a portable preservation system in accordance to one or more embodiments;

FIG. 2a shows a side view a portable preservation system in accordance to one or more embodiments;

FIG. 2b shows a side cross-sectional view of FIG. 2a of a portable preservation system in accordance to one or more embodiments;

FIG. 3 shows a top view of a portable preservation system in accordance to one or more embodiments;

FIG. 4a shows another side view of a portable preservation system in accordance to one or more embodiments;

FIG. 4b shows side cross-sectional view of FIG. 4a of a portable preservation system in accordance to one or more embodiments;

FIG. 5 shows an exploded isometric view of a portable preservation system in accordance to one or more embodiments;

FIG. 6a shows a side cross-sectional exploded view of a portable preservation system in accordance to one or more embodiments;

FIG. 6b shows a side cross-sectional view of FIG. 6a of a portable preservation system in accordance to one or more embodiments;

FIG. 7a shows a side view of another embodiment portable preservation system in accordance to one or more embodiments;

FIG. 7b shows a side cross-sectional view of FIG. 7a of a portable preservation system in accordance to one or more embodiments;

FIG. 8 shows another embodiment of a portable preservation system in accordance to one or more embodiments;

FIG. 9 shows another embodiment of a portable preservation system in accordance to one or more embodiments;

FIG. 10 shows another embodiment of a portable preservation system in accordance to one or more embodiments; and

FIG. 11 shows another embodiment of a portable preservation system in accordance to one or more embodiments.

### DETAILED DESCRIPTION

The embodiments of the invention described herein are not intended to be exhaustive or to limit the invention to precise forms disclosed. Rather, the embodiments selected for description have been chosen to enable one skilled in the art to practice the invention.

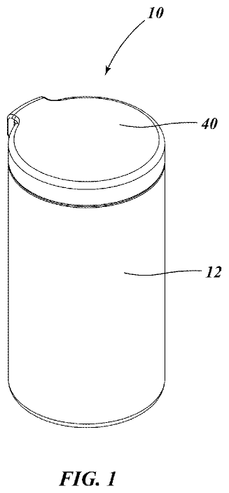

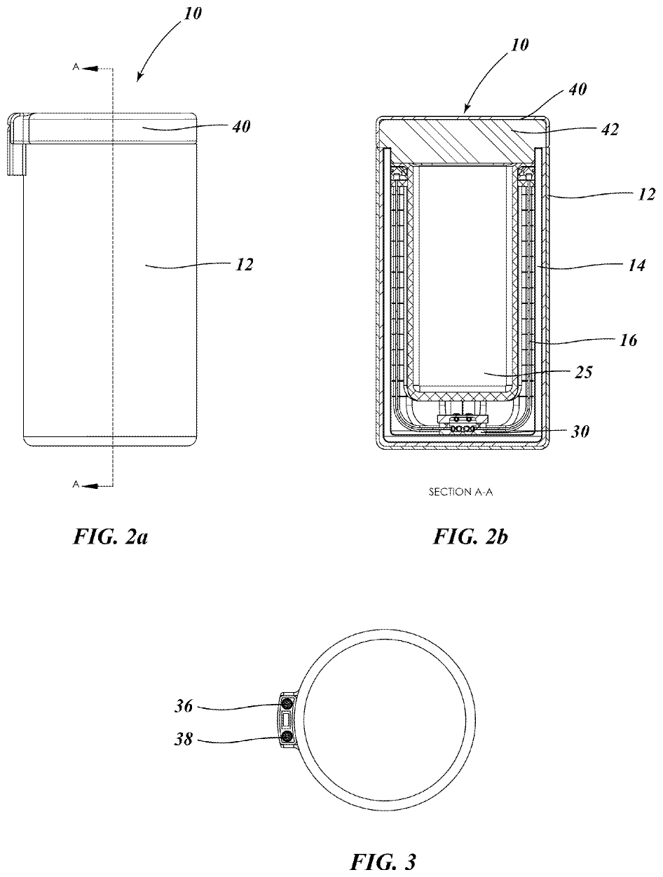

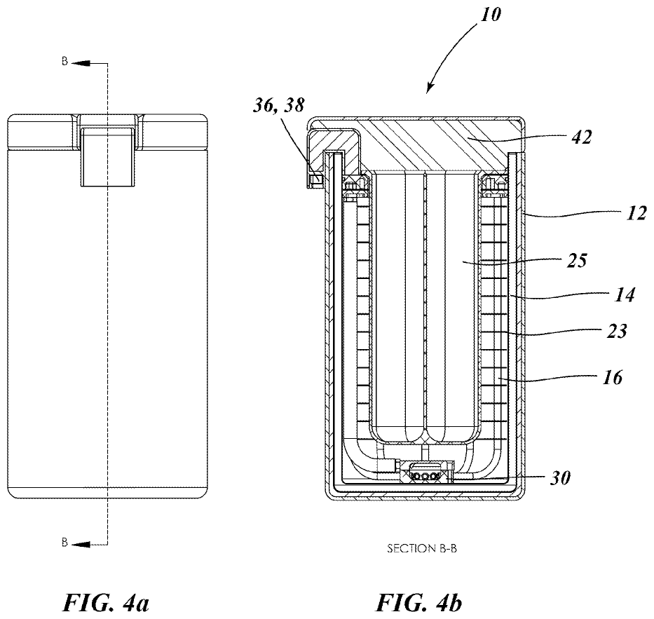

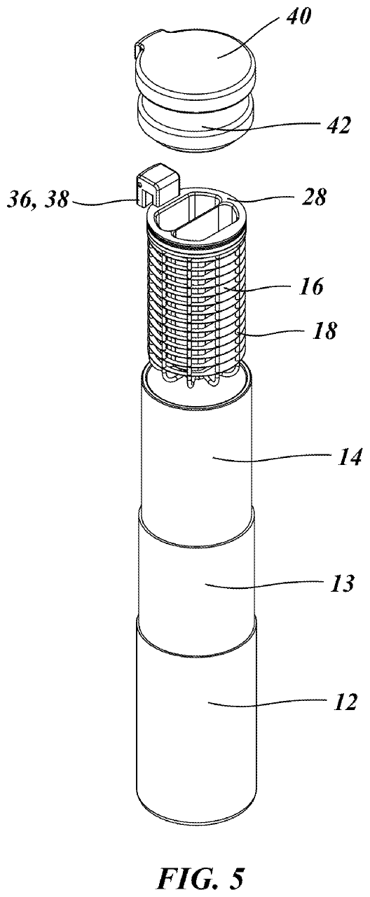

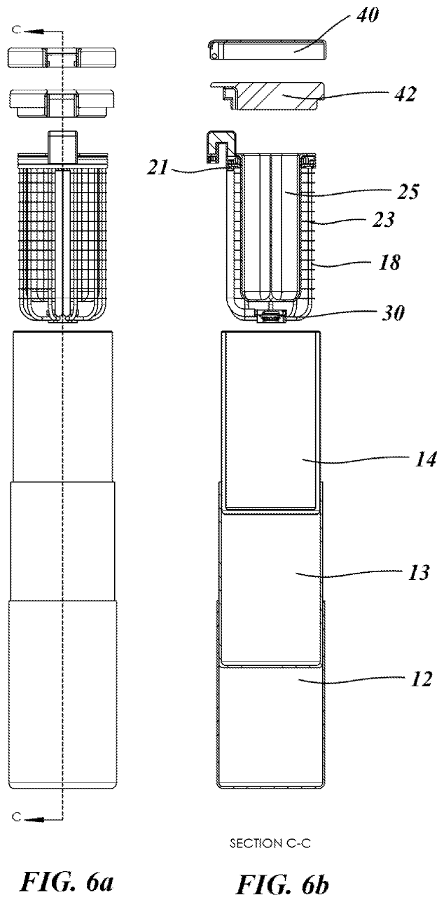

Referring initially to FIG. 1-7b, a portable preservation system shown generally at 10. The portable preservation system 10 comprises an outer container 12 wherein the outer container can be such as, for example, single wall, dual wall, triple wall or the like. The outer container 12 can be vacuum insulated stainless steel or aluminum or any other material that can hold a vacuum between the walls. The outer container 12 can have an opening on at least one side wherein the outer container can be such as, for example, circular, square, rectangular, or the like and in other embodiments the outer container can have partially closed end or closed end on at least one side. The outer container 12 can have an open end and closed end wherein in the preferred embodiment the outer container 12 is cylinder with an opening on one side. The portable preservation system 10 can further comprise an insulative layer 14 and a cooling layer 16. The outer container 12 can be any suitable shape or size wherein the outer container is dual walled wherein between the walls a vacuum is pulled creating an insulative barrier. The insulative layer 14 can be inserted into and contained within the outer container 12. The insulative layer 14 can be such as for example, polyurethane foam, cellulose, cellular glass, mineral wool, icynene, or the like. The insulative layer 14 can be the same shape as the outer container 12 or it can be any other suitable shape.

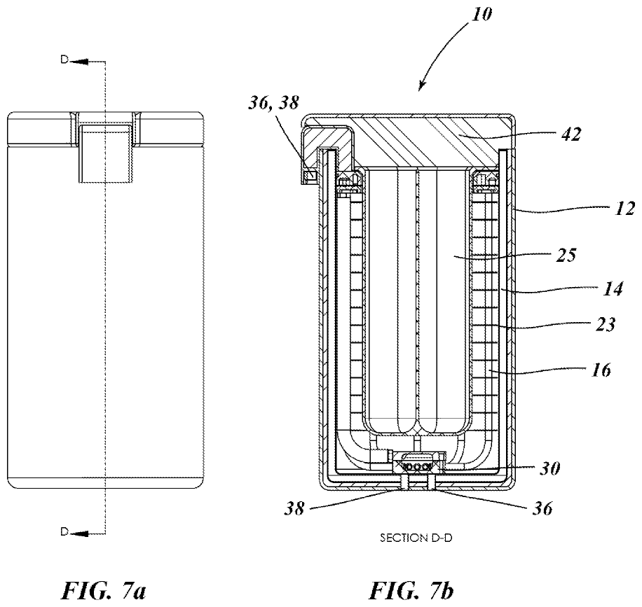

The cooling layer 16 can be inserted into and contained by the outer container 12 and the insulative layer 14 wherein the cooling layer can be such as, for example, phase change material (“PCM”), ice, salt hydrate, plant-based, sodium polyacrylate, or the like. The cooling layer 16 can integrated within or a separate layer from the insulative layer. The cooling layer 16 can be the same shape as the insulative layer 14 and the outer container 12. The cooling layer 16 can comprise at least one cooling or heating coils 18. The coils 18 can be copper, stainless steel, carbon steel, aluminum, or the like tubing that can transfer coolant from an outer cooling system (not shown) through the coils. The coils 18 can be coupled to at least one supply and return line which can be a supply line 38 and a return line 36 wherein the supply line and return line can be such as, for example, a quick disconnect, push to connect, twist to connect, plug and socket, or the like. The supply line 38 and return line 36 can be located on the bottom, side, top or the like of the portable preservation system 10 where FIG. 7b shows the inlet connection and the outlet connections on the bottom attached to a manifold 30 which disperses the coolant throughout the coils 18.

The coils 18 can be connected to a manifold 30 located at the bottom, top, or side of the container wherein the inlet connection can allow for the coolant to flow through the coils, and outlet connection can allow for the coolant to exit the coils as it flows through the coils back to the external cooling system (not shown). The coils 18 can extend from the topmost portion of the cooling layer 16 to the bottom most portion of the cooling layer and can be connected by a plurality of fins 23 which can support the coils and allow for the cooling to evenly disburse throughout the insulative layer 14 and an inner container 25. In certain embodiments the coils 18 can be coupled to at least one of the insulative layer 14 or inner container 25. In embodiments, the coils 18 can be any suitable shape or size, but in the preferred embodiments the coils are circular and partially or fully surround the inner container 25. The manifold 30 can have multiple connections coupled to the coils 18.

The inner container 25 can have at least one compartment wherein the inner container can have a wall thickness and can be any suitable shape. The inner container 25 can be coupled, placed or inserted into the cooling layer 16 wherein the coils and cooling layer can keep the contents of the inner container cold or warm. The inner container 25 can be made of any suitable material, but in the preferred embodiment it is made from such as, for example, aluminum, plastic, stainless steel, carbon steel, carbon fiber, or the like. The inner container 25 can have at least one open end 28 to accept at least one blood bag or biologic (not shown). The inner container 25 can be coated with such as, for example, copper, thermal spray, thermal barrier coating, or the like. The portable preservation system 10 can further comprise a cap wherein the comprises an outer cap 40 and inner cap 42 wherein the inner cap can be an insulative layer which can be such as, for example, Styrofoam, phase change material, or the like.

The outer container 12 can be a stainless-steel vacuum insulation and can have a thin coating of copper on the inner surface to reduce thermal radiation between the walls. This multilayer insulation (MLI) is a technology used in space, cryogenic, and other thermally demanding applications to minimize thermal radiation between the walls of vacuum insulation (like a dual wall stainless). Typically, a thin, metallized plastic film is stacked in the vacuum space. The thin plastic layer has a low thermal conductivity, and the metallized layers reflect the thermal radiation with each layer, providing a highly effective radiant barrier.

Referring to FIG. 8 a portable preservation system 10 without the outer container showing another embodiment wherein the coils 18 can spiral around the cooling layer 16 and the inner container wherein the inlet and outlet can be either on the top, bottom, or side and can be on opposite ends of each other or the same end. The coils 18 can be integrated within the cooling layer 16 or can be on the inner core or outer core of the cooling layer.

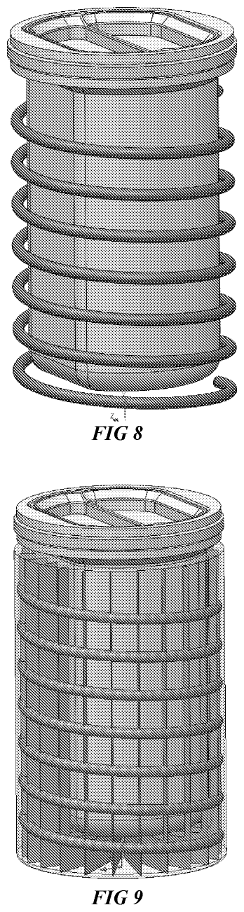

Referring to FIG. 9 a portable preservation system 10 without the outer container showing another embodiment wherein the coils are a helical coil with a plurality of fins 23 wherein the fins can be even or unevenly spaced around the cooling layer 16. The fins 23 can be copper, stainless, carbon, titanium, aluminum or the like. The fins 23 can extend vertical or horizontal around the inner container. The fins 23 can be integrated within the cooling layer 16 or it can be on the outer or inner surface of the cooling layer. The fins 23 and cooling layer can substantially come into contact with the inner container wherein the cooling layer fins 23 can transfer cool or heat to the inner container.

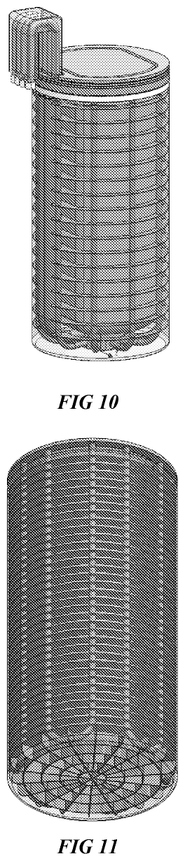

Referring to FIG. 10 a portable preservation system 10 without the outer container showing another embodiment wherein the coils are a plurality of coils extending from the top to the bottom wherein the coils can terminate at a manifold 30 that can be place on the bottom, top or side of the inner container wherein the Referring to FIG. 11 a portable preservation system 10 without the outer container showing another embodiment wherein the coils 18 are a manifold 30 with a plurality of fins 23 and coils and the coils form a u-shape and connect at the top or can connect at the bottom by a manifold 30.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the embodiments otherwise claimed. No language in the present specification should be construed as indicating any non-claimed element essential to the practice of the disclosed embodiments.

What is claimed is:

1. A portable preservation system comprising:
an outer container having at least one open end;
an insulative layer wherein the insulative layer is placed in and coupled to the outer container;
at least one supply line and at least one return line wherein at least one coil is coupled between the supply line and the return line wherein the coil partially surrounds an inner container; and
a cap.

2. The portable biologic preservation system of claim 1, wherein the inner container has at least one compartment.

3. The portable biologic preservation system of claim 2, wherein the insulative layer is coupled between the coils and the outer container.

4. The portable biologic preservation system of claim 2, wherein the insulative layer is phase change material.

5. The portable biologic preservation system of claim 2, wherein the coil is copper tubing.

6. The portable biologic preservation system of claim 1, wherein the coils are coupled to a manifold wherein the manifold evenly disburses a coolant throughout the coils.

7. The portable biologic preservation system of claim 1, wherein the cap comprises a outer cap and inner cap wherein the inner cap is a cap insulative layer.

8. The portable biologic preservation system of claim 1, wherein the supply line and the return line are quick disconnects.

9. The portable biologic preservation system of claim 1, wherein the coils further comprise fins wherein the fins are coupled to or come into contact with the insulative layer and the inner container.

10. The portable biologic preservation system of claim 1, wherein the outer container is dual walled vacuum insulated stainless steel.
